(19) United States
(12) Patent Application Publication
(10) Pub. No.: US 2017/0347113 A1
(43) Pub. Date: Nov. 30, 2017

(54) LOCAL DYNAMIC RANGE ADJUSTMENT COLOR PROCESSING

(71) Applicant: KONINKLIJKE PHILIPS N.V., EINDHOVEN (NL)

(72) Inventor: Wiebe DE HAAN, Eindhoven (NL)

(21) Appl. No.: 15/538,360

(22) PCT Filed: Jan. 15, 2016
(86) PCT No.: PCT/EP2016/050704

§ 371 Date: Jun. 21, 2017

(30) Foreign Application Priority Data
Jan. 29, 2015 (EP) 15153081.3

(51) Int. Cl. H04N 19/46; H04N 1/64; G06F 17/10

(52) U.S. Cl. CPC H04N 19/46; G06F 17/10; H04N 1/64

(57) ABSTRACT

For obtaining robust luminance dynamic range conversion in particular in coding technologies for defining a second image look from a first one, we describe an image color processing apparatus (205) arranged to transform an input color (R,G,B) of a pixel of an input image (Im_in) having a first luminance dynamic range into an output color (Rs, Gs, Bs) of a pixel of an output image (Im_res) having a second luminance dynamic range, which first and second dynamic ranges differ in extent by at least a multiplicative factor 2, comprising: -a color transformer (100) arranged to transform the input into the output color, the color transformer having a capability to locally process colors depending on a spatial location (x,y) of the pixel in the input image (Im_in); -wherein the color processing apparatus (205) comprises a geometric situation metadata reading unit (203) arranged to analyze received data (220) indicating that a geometric transformation has taken place between an original image (Im_orig), on which geometric location data (S) was determined for enabling a receiver of that geometric location data to determine at least one region of the original image, and the input image.

### FIELD OF THE INVENTION

The invention relates to apparatuses and methods and resulting products like data storage or transmission products or signals, which enable coordinated spatially localized color processing used in the transformation of images to make them colorimetrically correctly graded for display on at least two displays of different dynamic range and typically different peak brightness.

### BACKGROUND OF THE INVENTION

Recently a number of very different displays have appeared on the market, in particular television signal receiving displays (televisions) with very different peak brightness. Whereas in the past the peak brightness (PB) of so-called legacy low dynamic range (LDR) displays differed by at most something like a factor 2, the recent trend to ever higher peak brightness has resulted in so-called high dynamic range (HDR) televisions of 1000 nits and above, and displays of 5000 nit PB, and it is assumed that soon various displays of such higher PBs will be on the market. Even in movie theaters one is recently looking at ways to increase the ultimate brightness dynamic range perceived by the viewer. Compared to a 100 nit LDR standard legacy TV, a e.g. 2000 nit display has a factor 20 more brightness, which amounts to more than 4 additional stops available. On the one hand, provided one used also a new generation HDR image or capturing system, this allows for much better rendering of HDR scenes or effects. E.g., instead of (soft) clipping the sunny world outside a building or vehicle (as would happen in a legacy LDR grading), one can use the additional available brightnesses on the luminance axis of the HDR TV gamut to display bright and colorful outside areas. This means that the content creator, which we will call the color grader, has room to make very beautiful dedicated HDR image or video content. On the other hand however, this creates a problem: LDR image coding was designed relatively starting from white, and well-illuminated to middle gray of 18% reflection, which means that typically display-rendered luminances below 5% of a relatively low PB of say 100 nit will typically be seen by the viewer as difficult to discriminate dark greys, or even depending on surround illumination indiscriminatable blacks. On a 5000 nit display there will be no problem with this optimally graded HDR image: 5% of 5000 nit is still 250 nit, so this will look like a normal interior e.g., and the highest 95% could be used purely for HDR effects, like e.g. lamps, or regions close to such lamps i.e. brightly lit. But on an LDR the rendering of this HDR grading will go totally wrong (as it was also not created for such a display), and the viewer may e.g. only see hot spots corresponding to the brightest regions on a near-black region. In general, re-gradings are needed for creating optimal images for displays which are sufficiently different (at least a factor 2 difference in PB). That would happen both when re-grading an image for a lower dynamic range display to make it suitable for rendering on a higher dynamic range display (e.g. 1000 nit reference display content color processed for rendering on an actual display of 5000 nit PB), as the other way around, i.e. downgrading an image so that it would be suitable for display on an actual display of lower PB than the reference display associated with the grading which is coded as video images. For conciseness we will only describe the scenario where an HDR image or images is to be downgraded to LDR.

Since HDR technology (by which we mean a technology which should be able to handle at least some HDR images, but it may work with LDR images, or medium dynamic range images, etc. as well) will percolate in various areas of both consumer and professional use (e.g. cameras, data handling devices like blu-ray players, televisions, computer software, projection systems, security or video conferencing systems, etc.), we will need technology capable of handling the various aspects in different ways.

In Wo2013/144809 we formulated generically a technique to perform color processing for yielding an image (Im_res) which is suitable for another display dynamic range (typically the PB suffices to characterize the different display dynamic ranges and hence optimally graded images) than the reference display dynamic range associated with the input image (Im-in), which forms good prior art for the below elucidated invention to improve thereupon. We reformulate the principles concisely again in FIG. 1, in a manner closer to current actual embodiments of the same principle. The various pixels of an input image Im_in are consecutively color processed by a color transformer 100, by multiplying their linear RGB values by a multiplication factor (a) by a multiplier 104, to get output colors RsGsBs of pixels in an output image Im_res. The multiplication factor is established from some tone mapping specification, which may typically be created by a human color grader, but could also come from an auto-conversion algorithm which analysis the characteristics of the image(s) (e.g. the histogram, or the color properties of special objects like faces, etc.). The mapping function may coarsely be e.g. gamma-like, so that the darker colors are boosted (which is needed to make them brighter and more contrasty for rendering on the LDR display), at the cost of a contrast reductions for the bright areas, which will become pastellized on LDR displays. The grader may further have identified some special object like a face, for which luminances he has created an increased contrast part in the curve. What is special now is that this curve is applied to the maximum of the R,G, and B color component of each pixel, named M (determined by maximum evaluation unit 101), by curve application unit 102 (which may cheaply be e.g. a LUT, which may be calculated e.g. per shot of images at a receiving side which does the color processing, after typically having received parameters encoding the functional shape of the mapping, e.g. a gamma factor). Then a multiplication factor calculation unit 103 calculates a suitable multiplication factor (a) for each currently processed pixel. This may e.g. be the output of the tone mapping function F applied to M, i.e. F(M), divided by M, if the image is to be rendered on a first target display, say e.g. a 100 nit LDR display. If an image is needed for e.g. an intermediate display, e.g. 800 nit PB (or another value, maybe higher than the reference display PB of the HDR input image Im_in), then a further function G may be applied to F(M)/M rescaling the amount of multiplicative mapping of the input color to the value appropriate for the display dynamic range for which the image is suited (whether it is directly rendered on the display, or communicated, or stored in some memory for later use).

The part we described so far constitutes a global color processing. This means that the processing can be done based solely on the particular values of the colors of a consecutive set of pixels. So, if one just gets pixels from e.g. a set of pixels within a circular sub-selection of an image, the color processing can be done according to the above formulated principle. However, since human vision is very relative, whereby the colors and brightnesses of objects are judged in relation to colorimetric properties of other objects in the image (and also in view of various technical limitations), there is a desire to do local processing. In some image(s) one would like to isolate one or more object(s), like a lamp or a face, and do a dedicated processing on that object. However, in our technology, this forms part of an encoding of at least one further grading derivable from an image of pixels of a master grading (here LDR derived from HDR). I.e., the color processing is needed to construct by decoding an LDR image if needed. The fact that the local processing principle is used in an encoding technology has technical implications, inter alia that one needs a simple set of basic mathematical processing methods, since all decoding ICs or software out in the field needs to implement this, to be able to understand the encoding and create the decoder LDR image(s). The simple principle which is not too expensive in number of calculations yet sufficiently versatile that applicant introduced in Wo2013/144809, does a grader-specified dual testing by a region evaluation unit 108. This unit evaluates both a geometric and colorimetric condition. Geometrically, based on the coordinates of the current pixel (x,y), it checks e.g. whether the pixel is within a rectangle (x_s, y_s) to (x_e, y_e). Colorimetrically, it can e.g. check whether the luminance or max (R,G,B) is above a threshold (in which case the pixel is evaluated to belong to the to be specially processed region) or below (in which case it is not), or a more advanced evaluation of the color properties of the current to be processed pixel is performed. The color transformer 100 may then e.g. load another tone mapping LUT depending whether the pixel is not in the special region and to be globally processed or to be locally processed, or two parallel processing branches may be used etc.

This local color processing may work fine if the output image is perfectly geometrically overlapping with the input image (i.e. for each pixel of the output image the result would be correct because we know how to classify it based on the input image pixels). Or, formulated more specifically in another scenario, in which the pixel evaluation algorithms were generated separately from when they are needed for decoding an LDR image by processing the HDR pixel colors (e.g. by a grader a long time before, at another physical location, and on another apparatus namely an encoding apparatus), local processing would work well if the geometrical formulations of the selection areas for classifying the pixels into several color processing classes are at the same absolute pixel positions both in the image on which they were defined (e.g. by the grader), and the image on which they are to be used for local color processing. A practical problem needing a further technical solution is that in practice however, at least some part(s) of an image may be shifted before it is to be re-graded. E.g. a rectangle may be defined on an original say 4K image, but an apparatus intermediate in the image handling chain between content creation and the ultimate image using by e.g. a display, may e.g. make a small picture-in-picture (PIP) version of this image, by scaling it to e.g. a quarter of the size, and put it offset in an upper-right corner of e.g. a 2K image, whilst filling the remainder of the 2K image with computer graphics content, e.g. a solid blue color.

Suppose now that in the center of the 4K image, defined as within a circle of a radius of 20 pixels, there was a sun, which was 10 times brighter than the surrounding pixels in the HDR image, and which in the HDR-2-LDR conversion had to be set to (R,G,B)=(255,255,255) no matter what the global processing was on the remainder of the pixels (or vice versa, LDR image colors may be boosted to a maximum of e.g. 50% PB for all non-sun pixels, even if they had a white color in the LDR image as received primary image, but the sun has to be mapped to the maximal code or corresponding luminance of the HDR decoded grading from the LDR image). A receiving side apparatus gets the data for reconstructing the circular selection area, and gets some image data to be dynamic range converted. If the receiving apparatus, say a television, gets the original 4K image, it can perfectly boost the sun with the local processing, as desired and encoded in this algorithm by the grader. If after further geometric transformation it gets the PIP version, even if also a 4K image, the circle will select the incorrect pixels, and e.g. draw a white circle where there was supposed to be blue background graphics. I.e. there are possibilities for this encoding technology to create incorrect decoded images, which needs a correcting technology.

### SUMMARY OF THE INVENTION

The above problem is solved by an image color processing apparatus (205) arranged to transform an input color (R,G,B) of a pixel of an input image (Im_in) having a first luminance dynamic range into an output color (Rs, Gs, Bs) of a pixel of an output image (Im_res) having a second luminance dynamic range, which first and second dynamic ranges differ in extent by at least a multiplicative factor 2, comprising:

a color transformer (100) arranged to transform the input into the output color, the color transformer having a capability to locally process colors depending on a spatial location (x,y) of the pixel in the input image (Im_in);

wherein the color processing apparatus (205) comprises a geometric situation metadata reading unit (203) arranged to analyze received data (220) indicating that a geometric transformation has taken place between an original image (Im_orig), on which geometric location data (S) was determined for enabling a receiver of that geometric location data to determine at least one region of the original image, and the input image.

The dynamic range of the HDR original images (master graded for the appropriate HDR look) will correspond to a peak brightness (PB) of e.g. 5000 nit or 1000 nit (and the lower end point will be close to zero, and can for the purpose of this invention be equated with zero), and the LDR images may typically be graded with PB=100 nit (or 50 nit for professional cinema video). We needed to develop a framework that could handle all issues of practically occurring HDR image or in particular video communication ((de)coding) and/or handling, which in the field will consist of simpler and more complex systems, which all need a good similar solution. Note that if applied in a display with certain peak brightness, the dynamic range conversion may be e.g. between a PB of 5000 nit of the master graded content, and 1500 nit of the display, or 1200 nit if it's another display. The skilled person understands that there may be various manners to communicate in the location data S how one can determine whether a pixel belongs to a specially treated local region (e.g. one can specify a rectangle and a colorimetric criterion to determine whether a color is within or outside a specific volume in color space, etc.).

We have elucidated in FIG. 2 the situation by one particular possible image processing apparatus which is comprised in a television knowing its own peak brightness and doing the required re-grading color processing therefore. The image transmitting apparatus delivering the required input image (Im_in) and other data according to the invention is in that specific example a blu-ray player, which in its turn gets the image and the functions (F) for color processing it to obtain at least one re-graded image stored on an introduced blu-ray disk. Various types of BD players may exist in the market in the future. Some will be able to process images, and already supply images re-graded as desired to the television. Some may even look at the functions, and could code additional functions. Most BD players will presumably do only little processing, and largely pass-through the information on the BD leaving the television to process. Some BD players may do absolutely nothing with the data, but they can at least fill the indicator 221, specifying that they have done at least some geometric processing, e.g. scaled the pixels of the original image (Im_orig) received on disk. The image (Im_in) which will become input for the television, will then be a different image, with the actual movie or program pixels occupying only part of it, and the other pixels e.g. being generated by the BD player, e.g. set to black, or some text, etc. In the simplest case the indicator may be a single bit, BSVid, which if set to 1 meaning that there was geometric processing and the receiving apparatus should be careful, and if set to 0, the input image is identical in geometric properties to the original image, and the original geometric location data (S) specifying how a special region for local processing can be determined (in the sun example white pixels within the circle being specified with data specifying its center position and radius) can be copied in the output signal (S_out) transmitted (whether over a real-time video communication link, or to a memory), and thereafter safely used by a receiver for local color transformation. Some BD players may also look a little at the geometric location data (S), and re-determine it to be correct for the new geometrical situation which occurred after the geometric transformation applied by the image transmission apparatus 201 to obtain Im_in. Although we only drew a BD playing system, the skilled person will understand that there may be many similar scenarios where a first image handling apparatus may apply some geometric transformation to the image(s), and needs to coordinate that with a second apparatus which ultimately receives the data, and has to potentially do local color processing. E.g. this may occur in professional systems, where the image transmission apparatus may then be a cable operator distribution unit, which inserts a commercial as a small PIP in a movie, and both the commercial and the movie are to be suitably dynamic range processed. Or the image color processing apparatus may be a computer, which simultaneously shows various image(s) and/or videos, e.g. in an internet-based graphical user interface, whereby the image(s) a received from various content sources, however with generic (i.e. scaled to their original size and position starting at (0,0)) processing instructions, unaware of how the computer software will place them all together in the UI, etc.

It is advantageous if the image color processing apparatus (205) receives the data (220) comprising an indicator (221) codifying that any geometric transformation has taken place, such as e.g. a scaling of the size of the region comprising the image pixels of the original image (Im_orig). It can then check the value of this indicator, and may then quickly decide whether e.g. it needs to determine what the new geometric situation is by itself (e.g. it may have a graphics detector and video detector, and therewith estimate which sub-rectangle contains the video, and therefrom re-determine the data to geometrically determine a special region to be locally processed, e.g. by recalculating the new left-uppermost pixel position of a rectangle, and its new size, this rectangle being a necessary first checking criterion because only pixels within its bounds should be processed locally, and outside of the rectangle never, i.e. those external pixels should be color transformed by the global processing functions, whatever their colors are), or whether the situation may be too risky, and only the global processing is applied. Usually the global processing already gives a reasonable look, and the local processing only increases the impact and quality of the image look, but if e.g. only a small PIP is shown for being able to follow the video, sufficient visibility of the darker parts realized by the global processing may be sufficient, and perfect quality may not be desired. I.e. the local processing can then be switched off.

Alternatively or in addition, the image color processing apparatus (205) receives the data (220) comprising a new recalculated value of at least one parameter of the geometric location data (S) codifying at which geometric position of the input image (Im_in) a pixel is to be processed locally, and it may receive in a second indicator (222) that at least one parameter of the geometric location data (S) has been recalculated from its original value. E.g. if the geometric transformation was a shift of the original image half of the size of the input image to the right (i.e. without scaling), to make room e.g. for a text menu, or received textual information, then only the position location for each local processing window needs to be updated, e.g. the left-uppermost coordinates of the rectangles. The image color processing apparatus (205) can use its geometric situation metadata reading unit (203) to evaluate the geometric transformation situation by reading the data, and e.g. by reading a bit BRec=1, it knows that all relevant data for calculating the geometric positions of pixels to be locally processed has been correctly re-determined by the transmitting apparatus already, hence this data can be safely used for doing the color processing. In some scenarios it would be relatively simple for a receiving side apparatus to autonomously determine, if it knows there is a special geometrically transformed region, where that region would be. Of course knowing absolutely nothing, i.e. not even the sole bit that there has been such a transformation issue being communicated, it may be risky that the receiver may not always decide correctly (e.g. in a news program there may be a small screen behind the news reader, which however is supposed to be transformed by the global color transformation of the main window). In other scenarios there may be complex graphics compositing, e.g. the PIP may be in its own frame, with banding, or maybe even a flower icon border or something, and then it may be more difficult for the receiver to determine where exactly a local processing position should be. Apparatus 201 can take that into account when deciding whether to send a single bit or an accurate codification of the geometrical situation.

Alternatively the image color processing apparatus (205) may receive a variant of the data (220) comprising data specifying the geometric transformation which has taken place. Any data which allows the receiving side to fully reconstruct the transformation (i.e. the relationship between pixel positions of the original Im_orig and input image Im_in), or stated otherwise the transformation of selection areas or specifications allowing the selection of image areas will do, so this may be e.g. the parameters defining an affine transformation. For the shift example, this data may be e.g. a fixed transformation code SHIFT and a number of pixels, and the receiving apparatus therefrom realizes that the original geometric location data (S) was transmitted, and that it can with the data (220) calculate the updated selection criteria for geometrically selecting the pixels to be locally processed itself. Note that the original image Im_orig may oftentimes typically be the image as it was e.g. captured from camera, or stored on some intermediate server after e.g. putting effects in a digital intermediate, but all references of regions to be locally processed may of course also be given in relation to e.g. some standardized, reference size image Im_orig (e.g. 10000×10000 pixels, absolute or relative specified), as long as every pixel location stays relocatable correctly throughout the image handling chain. In case more than one transformation is applied in the chain, there may be data to track the various transformations. E.g. the grading apparatus may already have specified the localized processing areas in a manner which still needs to be related to an actual image, e.g. some parts of a movie on BD disk in 4K and other in 2K, and the data of that geometrical mapping may also already be encoded on the BD disk, irrespective of which transformations the BD player may still do, and ultimately communicate on the image communication link, e.g. an HDMI cable to a television.

Following the same coordination principles, at an image source side there may be an image transmission apparatus (201) arranged to transmit at least one image (Im_in) comprising pixels with input colors (R,G,B), and arranged to transmit transformation data (226) specifying functions or algorithms for color transforming the input colors (R,G,B), in which the transformation data (226) comprises data for performing local color transformation, that data comprising geometric location data (S) enabling a receiver to calculate which pixel positions of the at least one image (Im_in) are to be processed with the local color transformation, wherein the apparatus comprises geometric situation specification means (212) arranged to encode data (220) indicating that a geometric transformation has taken place between an original image (Im_orig) on which the geometric location data (S) was determined and the input image. This apparatus may be included in a larger system, which may also perform further functions. E.g., it may be in a transcoder which transforms legacy LDR movies into HDR movies (or more precisely, data allowing to determine a number of re-gradings corresponding to various display PBs, of which at least one is a LDR grading, and at least one is a HDR grading). This transcoder may e.g. have a first output supplying to a first receiver the full resolution image(s), and a second output transmitting a geometrically processed variant of that image(s), yet with on both outputs exactly the same transformation data (226), i.e. both the tone mapping function(s) F to be locally applied, but also the same geometric location data (S) i.e. for extracting the regions from the original, not geometrically processed images. This device may then use one or more of the data (220) variants to coordinate the correct information allowing the various connected receivers to ultimately do the correct color transformations. In the simple elucidation of FIG. 2 we have assumed that all information is co-encoded in the transmitted image signal (S_out), e.g. as metadata, but the skilled person should understand that the metadata for color processing may also reside on a different server, e.g. for subscription to a higher quality or other dynamic range re-grading. In particular also for such scenarios it is important that all receivers ultimately know to which geometrical locations which local color processing specifications correspond.

Advantageously the image transmission apparatus (201) has the geometric situation specification means (212) arranged to encode in the data (220) an indicator (221) codifying that any geometric transformation has taken place, e.g. by means of a bit.

Advantageously the image transmission apparatus (201) has the geometric situation specification means (212) arranged to change at least one parameter of the geometric location data (S) compared to a value it received for that parameter. It can then already calculate new data for correctly identifying the pixels to be treated locally, so that the receiver need not do so.

As an alternative to that, the image transmission apparatus (201) has the geometric situation specification means (212) arranged to encode in the data (220) data specifying the geometric transformation which has taken place. If the receiver gets full information on how the pixels of Im_in have been mapped compared to those of Im_orig, that receiver can itself determine the strategy for doing the geometrical condition part of the evaluation whether pixels should undergo some local color transformation different from the local one. The transmitting apparatus need then not spend time to look at the data at all, and may just transmit it directly to the receiver (i.e. e.g. read BD data packets, and reformat them in packets of the image communication standard, e.g. HDMI, or a video broadcast standard, or an internet protocol etc.). To be more precise, the e.g. BD player may have done a decoding the images themselves (which may be done by its legacy decoder if we have enforced an HDR grading in an LDR encoding framework), but it need not bother with any data about dynamic range transformation, and need not have hardware or software for handling those specifics.

Advantageously a method of image color processing comprises the steps of:

analyzing received data (220) indicating that a geometric transformation has taken place between an original image (Im_orig), on which geometric location data (S) was determined for enabling a receiver of that geometric location data to determine at least one region of the original image, and the input image; and

transforming an input color (R,G,B) of a pixel of an input image (Im_in) having a first luminance dynamic range into an output color (Rs, Gs, Bs) of a pixel of an output image (Im_res) having a second luminance dynamic range, which first and second dynamic ranges differ in extent by at least a multiplicative factor 2, wherein the applied color transformation depends on the value of the received data (220).

Advantageously a method of image color processing performs only global color transformation if an indicator (221) in the received data indicates that a geometric transformation has occurred.

Advantageously a method of image color processing performs a redetermination of the geometric geometric location data (S) if the analyzing concludes that a geometric transformation has occurred.

Advantageously a method of image transmission comprises:

obtaining an image (Im_in);

obtaining transformation data (226) for color transforming the image (Im_in);

determining whether the image (Im_in) is geometrically deformed compared to an original image (Im_orig) which was used when determining the transformation data; and

transmitting the image (Im_in), the transformation data (226), and data (220) indicating that a geometric transformation has taken place between the original image (Im_orig) and the input image.

To coordinate any transmitting and receiving apparatus, there may be an image signal comprising: pixel color data (RGB) of pixels of an image (Im_in), transformation data (226) for color transforming the image (Im_in), and data (220) indicating that a geometric transformation has taken place between an original image (Im_orig) which was used for determining the transformation data (226) and the input image (Im_in). Note that although we elucidated our invention with a particularly useful linear RGB-type dynamic range processing, the problem and solution of the local dedicated color processing versus geometric image transformations may of course also occur in other dynamic range conversion, e.g. when boosting with a local boost image, doing color processing in an Yuv, or YCrCb representation, etc.

Furthermore, computer program products may embody the various embodiments of our invention by comprising code codifying each of the steps of any of the above methods, thereby when run enabling a processor to perform that respective method.

### BRIEF DESCRIPTION OF THE DRAWINGS

These and other aspects of any variant of the method and apparatus according to the invention will be apparent from and elucidated with reference to the implementations and embodiments described hereinafter, and with reference to the accompanying drawings, which drawings serve merely as non-limiting specific illustrations exemplifying the more general concept, and in which dashes are used to indicate that a component is optional, non-dashed components not necessarily being essential. Dashes can also be used for indicating that elements, which are explained to be essential, are hidden in the interior of an object, or for intangible things such as e.g. selections of objects/regions, indications of value levels in charts, etc.

In the drawings:

FIG. 1 schematically illustrates a possible color processing apparatus for doing dynamic range transformation including local color processing, which color processing will typically include at least changing the luminances of objects in an input image;

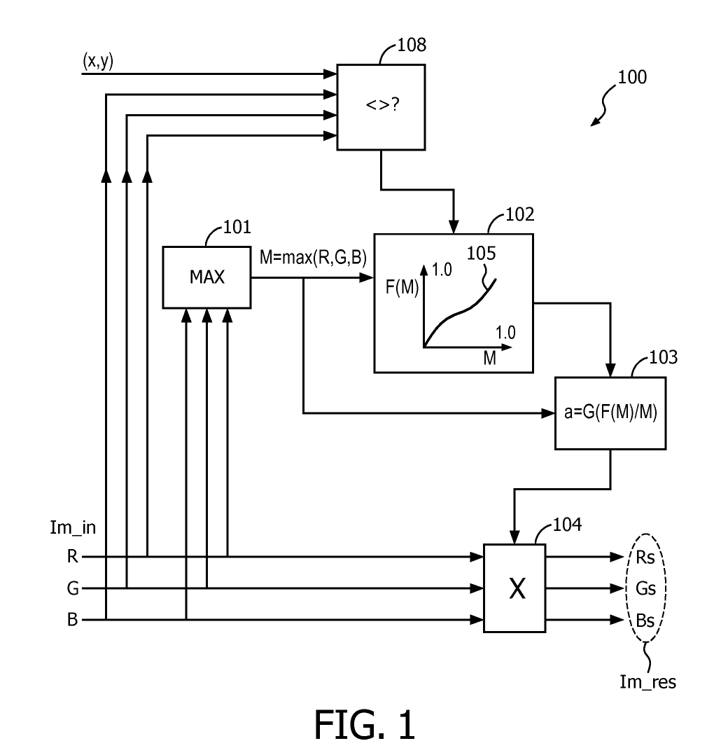

FIG. 2 schematically illustrates an example of a system which is arranged to coordinate the dynamic range color transformations needed, when any source apparatus may perform various geometrical transformations on an image to be dynamic range color transformed;

FIG. 3 elucidates with one possible example the problems that can occur in practical HDR image or video handling systems which make use of image look encoding on a local basis; and

FIG. 4 schematically illustrates basic functionalities of a possible typical HDR image or video handling apparatus, which will supply HDR image(s) to a further apparatus via some image communication technology.

### DETAILED DESCRIPTION OF THE DRAWINGS

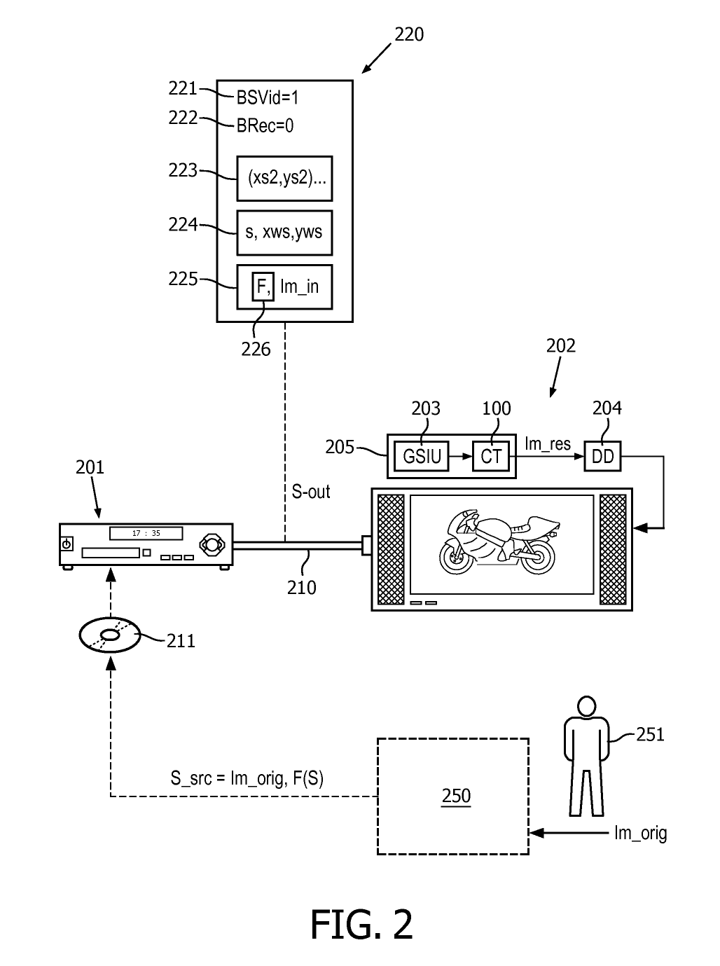

FIG. 2 shows an easy to understand practical example of how one can embody our invention. The skilled reader will understand that one can use the same component configurations in other HDR video handling systems, so we by no means meant this to be any limitation of our invention's basic framework principles. Suppose a grader 251 has made a master grading, which is an HDR grading on an image creation apparatus 250. This image may be seen as a normalized image (with R,G,B having values in [0,1]), i.e. still irrespective of its optimal rendering. In other words, the statistics of the color values will determine on which display with which peak brightness this image is best shown (typically thought there may also be included in the coded image signal S_src a peak brightness of an associated reference display, stating that this image is correctly graded for display on e.g. a 2000 nit display). Because of the normalization, this image may be stored in a legacy video encoding, e.g. HEVC with 10 bits per channel. As such an HDR only image encoding would only render correctly on HDR displays however, the grader needs to include some color transformation function data (F) to be able to calculate at least an 100 nit legacy LDR grading from the coded HDR image (Im_orig). The grader will have specified this function(s), and more importantly the data S specifying for which pixel locations at least one local color transformation should be done, based on the geometry of the original image (Im_orig) he was working on. Although many image communication technologies are possible, in this example we assume the data (HDR image+functions for re-grading at least to an LDR grading) is stored on a blu-ray disk, with HDR capabilities, which can be purchased by a consumer. A BD player as example of the image transmission apparatus (201) can read at least the image data on the disk, and play it out at normal position, size etc. It therefore sends this image data, and the functions F, in an image signal S-out to the image color processing apparatus (205), which is in this example incorporated in a television with LED backlights as example of a receiving apparatus (202), but this receiving apparatus could be also e.g. a data storage server with calculation capabilities for re-grading images before storage, etc. In the scenario where the BD player just passes through the geometrically unmodified video, there is no issue. The television will do the required color transformation to get a re-grading optimal for its physical characteristics, and send that image to a display driver 204, e.g. for driving a backlight and LCD pixel valves. However, e.g. if the user starts interacting with the menu of the BD player, it may show images with text and a small rescaled version of the content video, and send that to the television over an image connection (210), e.g. an HDMI cable, or wireless image communication channel, etc.

To communicate the geometrical transformation situation, the BD player may add in the signal S-out one or more types of additional data (220), characterizing the geometrical transformation situation, so that the receiving side can understand it. E.g. there may be a simple indicator (221) merely codifying that any geometric transformation has taken place. But the BD player may also recalculate the data needed for obtaining the spatial positions of pixels to be locally processed in accordance with the geometric transformation it applied. This it may indicate in the data as e.g. a second indicator (222) indicating that at least one parameter of the geometric location data (S) has been recalculated from its original value, and geometric selection parameters (223), which now do not contain the original geometric location data (S), but e.g. a new starting point (xs2, ys2) as left-uppermost point of a rectangle, etc.

In case the receiving apparatus is to re-determine how the pixels to be locally processed should be determined geometrically, the transmitting apparatus may add in the data (220) transformation data (224) specifying the geometric transformation which has taken place. This may e.g. be a scale factor (s=e.g. ¼), and an offset (xws, yws) as a number of pixels, or more complex information codifying more complex transformations, which need not necessarily comprise all original pixel, but may also e.g. select a subset of the Im_orig in some pass-through window, etc. Finally, the BD player will transmit the data required for doing the correct color transformations (F) and the primary image (Im_in) which can be used directly if a display is connected with the associated PB, or re-graded otherwise. This will be the image gradings encoded data 225.

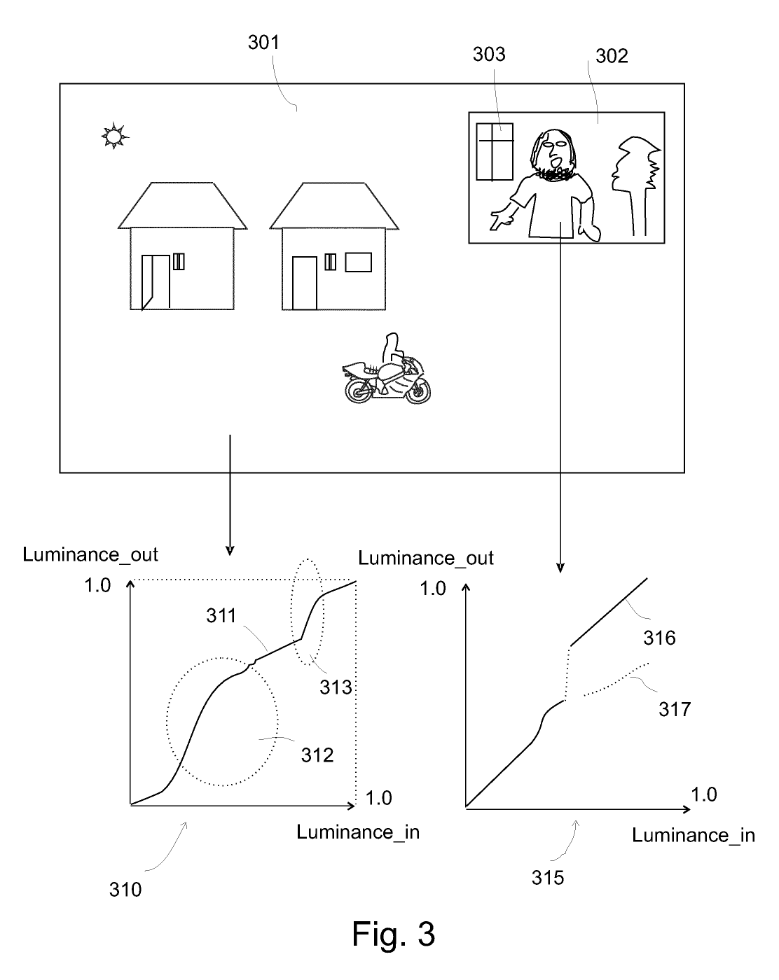

FIG. 3 shows a typical HDR image or in particular video handling scenario for which the present invention and its embodiments was designed. The reader should realize also that typically in HDR, there may not necessarily be only one image (corresponding to only one look having its relative luminances of its scene objects in a particular configuration of proportions of a first object luminance to a second one). This was the situation for legacy LDR video encoding, because there was only one 0-100 nit luminance range which existed by definition. Now however, one must cater for having all possible HDR scenes and their images rendered optimally on various possible final displays, with peak brightness of e.g. 100 nit, 400 nit, 1000 nit, 2000 nit, 5000 nit, and 10,000 nit. One can imagine that if one renders an image which has been color graded to look optimally bright on a 100 nit PB display as is on a 10,000 nit monitor or TV, that it may look painfully too bright. So a solution to this is that typically the better coding systems don't just encode a single set of HDR images (e.g. defined on a 5000 nit PB reference luminance range), but rather the encode the dual set of images being e.g. a 5000 nit grading and an legacy 100 nit grading (i.e. images having a look which is correct for them to be directly rendered, i.e. without needing further colorimetric transformation, on a legacy 100 nit LDR display). And furthermore, to save on bandwidth, one may typically want to encode the second image(s) with as little data overhead as possible, i.e. as a functional or algorithmic transformation of the first set of images, which does get sent as actual images, i.e. DCT-ed pixel blocks, e.g. according to the HEVC standard. I.e. e.g. one sends a set of LDR images (which can be used for direct rendering on LDR displays, but surprisingly at the same time double as images for a HDR high dynamic range look to supply say a 4000 nit display with an optimally or reasonably looking image), and one sends metadata allowing a receiver to transform the LDR images into HDR images being a close reconstruction of the HDR look images that were created by the content creator at a transmitting side, or the other way around, the metadata comprises functions to downgrade transmitted HDR images (HEVC encoded) to LDR images.

There would be no problem if we only used global transformations, but it has come to light that it may be advantageous or necessary in some scenarios to define some of the color transformations locally (i.e. although e.g. the colors seen through a window 303 are to a certain extent similar to colors in the remainder of the image (of PIP 302), they nonetheless are transformed differently because they need to become e.g. very bright, or vice versa subnominally dim). One should realize that this is not just any mere transformation, with which one can play at will, but it is an actual encoding of new images, which ideally need to look precisely as their content creator defined them, i.e. significant special technical care is needed to keep handling them correctly anywhere in any HDR handling apparatus or chain. So we don't just have a situation of handling image resolutions, but actually a handling of image re-definitions, namely a correct adjustment of the color transformation functions.

In FIG. 3 we see an example of a PIP, although other similar scenarios are conceivable (e.g. POP, display on a second side display like a mobile phone, coarsening a part of an image to form a low resolution ambilight projected light pattern, etc.). For elucidation, we will assume without wanting to limit ourselves that this would be a scenario of say a blu-ray disk reader doing a PIP of say a second video stream containing some director comments.

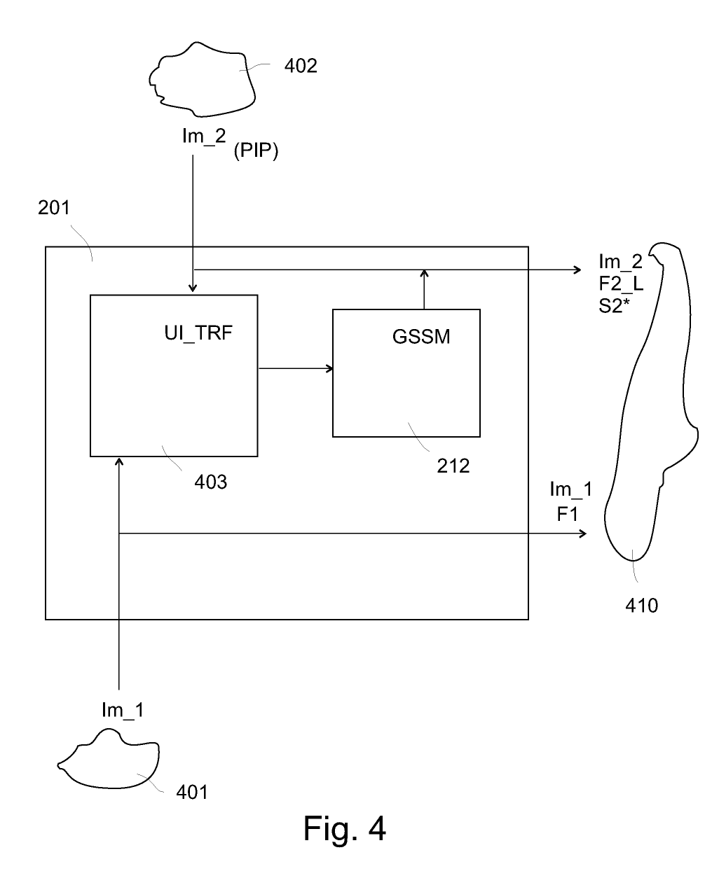

In the main area 301, there will be a movie. It may be defined according to some version of the possible HDR codecs, and it needs to be ultimately converted to output luminances Luminance_out to be rendered on the display. Now there are many different aspects in HDR coding, which are not needed to complicate the discussion of the present invention, e.g. the video may be encoded according to various code allocation functions or EOTFs relating luma codes to luminances, and it may be defined compared to a peak brightness e.g. 5000 nit, which may be different from that of the rendering display, e.g. 2500 nit. Furthermore, a display may want to do its own image processing etc. In any case, we can summarize the situation as a global mapping which we represent with custom transformation curve 311 between input luminances Luminance in (which would correspond on a 5000 nit luminance axis to the lumas and in general pixel colors received in the HEVC images, in particular Im_1 as in FIG. 4), and ultimate output luminances. Furthermore, it can be demonstrated that one may define this transformation on normalized luminance axes, but the 1.0 on the x-axis then corresponds to an actual 5000 nit, and the 1.0 on the y-axis e.g. to 2500 nit, the PB of the connected or to be ultimately supplied TV. In this example the curve dictates that one needs to brighten to some degree the darker regions (relative luminance sub-range 312), which may e.g. be a black motorcycle in a night scene, and we want to increase the contrast of some brighter regions (relative luminance sub-range 313), e.g. to see everything nicely crisp in the incandescently lit rooms of the houses as seen through the windows. This constitutes the colorimetric transformation graph 310 for the main video.

Now secondly, there is the PIP 302, which gets its own video/image(s), and has its own specific, and different color transformation (graph 315). If the system knew nothing, it would just apply the global transformation 311 also on those pixel colors. Here we assumed that we may have a global color/luminance transformation for the majority of the pixels, and a local transformation 316, e.g. to brighten the outside pixels as seen through window 303 (without losing sight of the generic concepts, the reader can take the example that this secondary video was quickly shot with a cheaper LDR camera, and not specifically HDR graded with much care, and basically it is converted into rough pseudo-HDR by keeping all the pixels LDR, and only boosting the bright outside region 303. So actually we are interested in the functional luminance transformation shape 316 for processing locally the brighter outside pixels only, and we don't need to bother in this elucidation with what happens to other pixels, like pixels having similar luminances elsewhere in the PIP video (getting transformation 317), or the transformation for the darker pixel colors.

But it is important that the local transformation of the outside region 303 will go correctly, otherwise unpleasant and unnatural looking colors may appear, or worse, geometric artefacts may occur in the ultimate image, and not necessarily the PIP region, but potentially also in the main movie.

FIG. 4 shows a little more of a possible apparatus which creates the geometric situation information. We will again for simple elucidation describe a BD-player, although the skilled person understands that in a similar manner such a system may occur in many apparatuses, e.g. a video compositor in a TV truck mixing feeds from various cameras, a video inserter in a local cable distribution centre, an video server on internet compositing two streams, etc.

A first image (or set of images) Im_1 comes from a first image source 401, and a second image Im_2 (which we assume gets e.g. PIP-ed, but of course several other geometric transformations are possible, even with dynamically moving regions etc.) comes from a second image source 402. Of course for a simple elucidation of our principles one may assume both come from a blu-ray disk, but of course, even with blu-ray applications the second image may come from a server over an internet connection, or in case of a live production apparatus embodiment from a camera etc.

A geometrical transformation unit 403 does a geometrical transformation on the video (Im_2), e.g. in accordance with rules of a user interface software, e.g. it scales and repositions the video in a PIP. Now the assumption is that a receiving device later in the chain like a television still has to do some of the dynamic range processing, be it only the conversion to its dynamic range (e.g. 5000 nit PB video to the 2500 nit display dynamic range). If the apparatus 201, say a BD player would do all optimization color transformation and directly supply the display drivers of a (dumb) display with the correct values, there would in most scenarios also not be a problem. A geometric situation specification means 212 can get the information of what was done geometrically from the geometrical transformation unit 403, and then define the situation parameters which need to be communicated to the receiving side, according to whatever embodiment is desired for a certain application. As said, some embodiments need no detailed codification of which geometric transformation(s) were actually done, but only a bit indicating that something was done, and that this is no longer the pure original movie video Im_1 to which the transformation function(s) F1 corresponds (which incidentally as we have shown in research can apart from defining a 100 nit look from say the 5000 nit image(s) Im_1 or vice versa, also be used to calculate the optimal looking images for rendering on a display of peak brightness unequal to those two values, say 2500 or 1400 nit). So in some scenarios geometric situation specification means 212 will generate a sole bit to be output in the video signal (or multiple correlated video signal parts potentially being communicated via different mechanisms) going to some output system 401 (e.g. directly to a display via a HDMI if apparatus 201 resides at a final consumer premise, or to a network video storage memory for transcoders or apparatuses for networked video delivery etc.). This may be good for application scenarios where an incorrect decoding is not necessarily too critical, and the receiving side apparatus can then switch to a safe mode (e.g. no local processing, in the main and/or secondary region). That will in principle lead to the wrong decoding, i.e. reconstruction of the wrong e.g. HDR image look for the PIP, getting incorrect colors in some areas, namely at least those which needed to be locally reconstructed. E.g., in the example of FIG. 3, we would get by using the global luminance transformation curve (i.e. on those brighter pixels its part 317) sunny outside colors which are too dark. But the apparatus 201 could determine what the severity of the situation would be, e.g. a small window in only a PIP maybe needn't be perfect. This will depend on various factors, such as the precise geometrical situation, but also the details of the image content, but also the characteristics of the ultimate rendering (e.g. on a 1000 nit TV an error in the window may be less severe than on a 5000 nit TV, and if the error is that the region becomes too bright with the global mapping, especially if close to the PB, then it may be very inappropriate for TVs above 3000 nit, and less problematic that there is an error on TVs of PB below 1000 nit). As to the influence of content, note that the local transformation may have been done primarily for getting better contrasts, or less artefacts like banding, and the apparatus 201 can take that into account in its decision of how to encode the necessary geometric transformation information. Especially if a human is present and interacting with the apparatus 201, e.g. in a video production system, he can check what the severity of the impact of incorrectly doing the decoding by e.g. dropping the local transformations would be, especially if he has a fixed or range final display in mind. Automatic apparatuses may calculate an error measure which takes into account the amount of pixels (size of the local region), and the differences of the colors of the reconstruction versus the ideal, and even further image information, of course only in case they do some HDR calculations (we designed the simpler variants also for cheap systems, which do (almost) nothing, and just pass true all the colorimetric coding parameters to another apparatus for it to do all calculations. I.e. if immediately rendered on some—especially if lower quality—display, the single bit solution may be appropriate, but if all data is archived for later use, the higher quality versions with all information encoded as precisely as possible may be in order.

In this example elucidation we assume that apparatus 201 just calculates new rules S2* to find the pixels of Im_2 on which the local color transformation (316) should be applied, and that local function shape F2_L is just directly passed through from being read as say metadata from video source 402 to the output, similarly to how Im_1 and F1 may typically be passed through in this embodiment for color processing by some receiving side apparatus.

The algorithmic components disclosed in this text may (entirely or in part) be realized in practice as hardware (e.g. parts of an application specific IC) or as software running on a special digital signal processor, or a generic processor, etc. They may be semi-automatic in a sense that at least some user input may be/have been (e.g. in factory, or consumer input, or other human input) present.

It should be understandable to the skilled person from our presentation which components may be optional improvements and can be realized in combination with other components, and how (optional) steps of methods correspond to respective means of apparatuses, and vice versa. The fact that some components are disclosed in the invention in a certain relationship (e.g. in a single figure in a certain configuration) doesn't mean that other configurations are not possible as embodiments under the same inventive thinking as disclosed for patenting herein. Also, the fact that for pragmatic reasons only a limited spectrum of examples has been described, doesn't mean that other variants cannot fall under the scope of the claims. In fact, the components of the invention can be embodied in different variants along any use chain, e.g. all variants of a creation side like an encoder may be similar as or correspond to corresponding apparatuses at a consumption side of a decomposed system, e.g. a decoder and vice versa. Several components of the embodiments may be encoded as specific signal data in a signal for transmission, or further use such as coordination, in any transmission technology between encoder and decoder, etc. The word “apparatus” in this application is used in its broadest sense, namely a group of means allowing the realization of a particular objective, and can hence e.g. be (a small part of) an IC, or a dedicated appliance (such as an appliance with a display), or part of a networked system, etc. “Arrangement” or “system” is also intended to be used in the broadest sense, so it may comprise inter alia a single physical, purchasable apparatus, a part of an apparatus, a collection of (parts of) cooperating apparatuses, etc.

The computer program product denotation should be understood to encompass any physical realization of a collection of commands enabling a generic or special purpose processor, after a series of loading steps (which may include intermediate conversion steps, such as translation to an intermediate language, and a final processor language) to enter the commands into the processor, to execute any of the characteristic functions of an invention. In particular, the computer program product may be realized as data on a carrier such as e.g. a disk or tape, data present in a memory, data traveling via a network connection—wired or wireless—, or program code on paper. Apart from program code, characteristic data required for the program may also be embodied as a computer program product. Such data may be (partially) supplied in any way.

The invention or any data usable according to any philosophy of the present embodiments like video data, may also be embodied as signals on data carriers, which may be removable memories like optical disks, flash memories, removable hard disks, portable devices writeable via wireless means, etc.

Some of the steps required for the operation of any presented method may be already present in the functionality of the processor or any apparatus embodiments of the invention instead of described in the computer program product or any unit, apparatus or method described herein (with specifics of the invention embodiments), such as data input and output steps, well-known typically incorporated processing steps such as standard display driving, etc. We also desire protection for resultant products and similar resultants, like e.g. the specific novel signals involved at any step of the methods or in any subpart of the apparatuses, as well as any new uses of such signals, or any related methods.

It should be noted that the above-mentioned embodiments illustrate rather than limit the invention. Where the skilled person can easily realize a mapping of the presented examples to other regions of the claims, we have for conciseness not mentioned all these options in-depth. Apart from combinations of elements of the invention as combined in the claims, other combinations of the elements are possible. Any combination of elements can be realized in a single dedicated element.

Any reference sign between parentheses in the claim is not intended for limiting the claim, nor is any particular symbol in the drawings. The word “comprising” does not exclude the presence of elements or aspects not listed in a claim. The word “a” or “an” preceding an element does not exclude the presence of a plurality of such elements.

1. An image color processing apparatus arranged to transform an input color of a pixel of an input image having a first luminance dynamic range into an output color of a pixel of an output image having a second luminance dynamic range, which first and second dynamic ranges differ in extent by at least a multiplicative factor 2, comprising:
a color transformer arranged to transform the input color into the output color, the color transformer having a capability to locally process colors depending on a spatial location of the pixel in the input image;
wherein the color processing apparatus comprises a geometric situation metadata reading unit arranged to analyze received data indicating that a geometric transformation has taken place between an original image, on which geometric location data was determined for enabling a receiver of that geometric location data to determine at least one region of the original image, and the input image;
and the color transformer is arranged to transform the input color into the output color in dependence on the geometric location data.

2. An image color processing apparatus as claimed in claim 1, in which the data comprises an indicator codifying that any geometric transformation has taken place, such as e.g. a scaling of the size of the region comprising the image pixels of the original image.

3. An image color processing apparatus as claimed in claim 1, in which the data comprises a new recalculated value of at least one parameter of the geometric location data codifying at which geometric position of the input image a pixel is to be processed locally.

4. An image color processing apparatus as claimed in claim 3 further comprising a second indicator indicating that at least one parameter of the geometric location data has been recalculated from its original value.

5. An image color processing apparatus as claimed in claim 1, in which the data comprises transformation data specifying the geometric transformation which has taken place.

6. An image transmission apparatus arranged to transmit at least one image comprising pixels with input colors, and arranged to transmit transformation data specifying functions or algorithms for color transforming the input colors in a first luminance dynamic range into output colors (RS, Gs, Bs) in a second luminance dynamic range, which first and second dynamic ranges differ in extent by at least a multiplicative factor 2, in which the transformation data comprises data for performing local color transformation, that data comprising geometric location data enabling a receiver to calculate which pixel positions of the at least one image are to be processed with the local color transformation, wherein the apparatus comprises geometric situation specification means arranged to encode data indicating that a geometric transformation has taken place between an original image on which the geometric location data was determined and the input image.

7. An image transmission apparatus as claimed in claim 6, in which the geometric situation specification means is arranged to encode in the data an indicator codifying that any geometric transformation has taken place.

8. An image transmission apparatus as claimed in claim 6, in which the geometric situation specification means is arranged to change at least one parameter of the geometric location data compared to a value it received for that parameter.

9. An image transmission apparatus as claimed in claim 6, in which the geometric situation specification means is arranged to encode in the data data specifying the geometric transformation which has taken place.

10. A method of image color processing comprising the steps of:
analyzing received data indicating that a geometric transformation has taken place between an original image, on which geometric location data was determined for enabling a receiver of that geometric location data to determine at least one region of the original image, and the input image; and
transforming an input color of a pixel of an input image having a first luminance dynamic range into an output color of a pixel of an output image having a second luminance dynamic range, which first and second dynamic ranges differ in extent by at least a multiplicative factor 2, wherein the applied color transformation depends on the value of the received data.

11. A method of image color processing as claimed in claim 10, which performs only global color transformation if an indicator in the received data indicates that a geometric transformation has occurred.

12. A method of image color processing as claimed in claim 10, which performs a re-determination of the geometric location data if the analyzing concludes that a geometric transformation has occurred.

13. A method of image transmission comprising:
obtaining an image;
obtaining transformation data for color transforming the image from input colors in a first luminance dynamic range into output colors in a second luminance dynamic range, which first and second dynamic ranges differ in extent by at least a multiplicative factor 2;
determining whether the image is geometrically deformed compared to an original image which was used when determining the transformation data; and
transmitting the image, the transformation data, and data indicating that a geometric transformation has taken place between the original image and the input image.

14. (canceled)

15. A computer program product comprising code codifying each of the steps in claim 1, thereby when run enabling a processor to perform that respective method.
